(19) United States
(12) Patent Application Publication
(10) Pub. No.: US 2024/0036230 A1
(43) Pub. Date: Feb. 1, 2024

(54) MILLIMETER-WAVE HUMAN BODY SECURITY CHECKING SYSTEM AND METHOD BASED ON DOUBLE STANDING POSTURES

(71) Applicants: NUCTECH COMPANY LIMITED, Beijing (CN); BEIJING SHENMUTEK COMPANY LIMITED, Beijing (CN)

(72) Inventors: Yingkang JIN, Beijing (CN); Pu WANG, Beijing (CN); Zheng LI, Beijing (CN); Mengjiao ZHAO, Beijing (CN); Jiao LONG, Beijing (CN); Nian LIU, Beijing (CN); Zhimin ZHENG, Beijing (CN)

(21) Appl. No.: 18/245,876

(22) PCT Filed: Sep. 18, 2021
(86) PCT No.: PCT/CN2021/119257

§ 371 Date: Mar. 17, 2023

(30) Foreign Application Priority Data
Sep. 21, 2020 (CN) 202010998420.9

(51) Int. Cl. G01V 8/00; G01S 13/88

(52) U.S. Cl. CPC G01V 8/005; G01S 13/887

(57) ABSTRACT

A method of millimeter-wave human body security checking based on double standing postures is provided, including: scanning and checking a body of a checked person in a first standing posture by using a millimeter-wave human body security detector, so as to obtain a first millimeter-wave human body image; scanning and checking the body of the same checked person in a second standing posture by using the millimeter-wave human body security detector, so as to obtain a second millimeter-wave human body image, wherein the second standing posture is different from the first standing posture (S10); and determining whether the checked person carries contraband based on at least the first millimeter-wave human body image and the second millimeter-wave human body image (S20). A system of millimeter-wave human body security checking based on double standing postures is provided, including: a millimeter-wave human body security detector (100) configured to: scan and check a body of a checked person in a first standing posture, so as to obtain a first millimeter-wave human body image, and scan and check the body of the same checked person in a second standing posture, so as to obtain a second millimeter-wave human body image, wherein the second standing posture is different from the first standing posture; and a processor (200) communicating with the millimeter-wave human body security detector (100) and configured to determine whether the checked person carries contraband based on at least the first millimeter-wave human body image and the second millimeter-wave human body image.

This application claims priority to Chinese Patent Application No. 202010998420.9, filed on Sep. 21, 2020, the entire content of which is incorporated herein by reference in its entirety.

### TECHNICAL FIELD

The present disclosure relates to a field of security checking, and in particular, to a system and a method of millimeter-wave human body security checking based on double standing postures.

### BACKGROUND

In order to ensure public safety, it is a desired means to conduct a security checking in an important public place. At present, the most widely used imaging security checking technologies are mainly X-ray imaging technology and millimeter-wave imaging technology. The millimeter-wave detection imaging technology has many advantages, such as no harm to a human body in use due to non-ionizing radiation, penetrating human clothing, and identifying various metal and non-metal contraband. In recent years, with a development of millimeter-wave technology and a reduction of device cost, the millimeter-wave imaging has been widely used in a field of human body security checking.

When a millimeter-wave device is used to perform a human body security checking, due to a restriction of a length of a detection array, only a region directly facing a scanning plane may obtain a high-quality image, and there may be problems such as image quality degradation at positions such as a side of the body, which may affect the detection efficiency. In addition, if a sheet-type object is placed perpendicular to the scanning plane, an image of the sheet-type object may not be visible due to a limitation of imaging angle. These problems may affect the efficiency and accuracy of security checking under a specific environmental condition.

### SUMMARY

According to an aspect of the present disclosure, there is provided a method of millimeter-wave human body security checking based on double standing postures, including: scanning and checking a body of an checked person in a first standing posture by using a millimeter-wave human body security detector, so as to obtain a first millimeter-wave human body image; scanning and checking the body of the same checked person in a second standing posture by the millimeter-wave human body security detector, so as to obtain a second millimeter-wave human body image, wherein the second standing posture is different from the first standing posture; and determining whether the checked person carries contraband based on at least the first millimeter-wave human body image and the second millimeter-wave human body image.

In some embodiments, the millimeter-wave human body security detector has a scanning surface for scanning the body of the checked person, and the method further includes: guiding the first standing posture and the second standing posture of the checked person so that a part of the body of the checked person scanned by the scanning surface when the body of the checked person is in the first standing posture is at least partially complementary to a part of the body of the checked person scanned by the scanning surface when the body of the checked person is in the second standing posture, and a combination of the first millimeter-wave human body image and the second millimeter-wave human body image obtained forms a roughly complete contour image of the body of the checked person.

In some embodiments, the first standing posture and the second standing posture are selected so that the combination of the first millimeter-wave human body image and the second millimeter-wave human body image at least includes images of front and sides of the body, armpits, inner and outer thighs, and inner arms of the checked person.

In some embodiments, the millimeter-wave human body security detector has a scanning surface for scanning the body of the checked person, and the method further includes: guiding or instructing the checked person to stand at a designated security checking position in the first standing posture, so that a front or back of the body of the checked person faces the scanning surface; and/or guiding or instructing the checked person to stand at a designated security checking position in the second standing posture, so that a side of the body of the checked person faces the scanning surface.

In some embodiments, at least one of a voice prompt and a visual prompt is used to guide or instruct the checked person to stand at the designated security checking position in the first standing posture or the second standing posture through a guidance device.

In some embodiments, the method further includes: determining whether the first standing posture of the checked person meets a requirement of a first designated standing posture; and/or determining whether the second standing posture of the checked person meets a requirement of a second designated standing posture.

In some embodiments, whether the first standing posture of the checked person meets the requirement of the first designated standing posture is determined before scanning and checking the body of the checked person in the first standing posture by using the millimeter-wave human body security detector; and/or whether the second standing posture of the checked person meets the requirement of the second designated standing posture is determined before scanning and checking the body of the checked person in the second standing posture by using the millimeter-wave human body security detector.

In some embodiments, the “determining whether the first standing posture of the checked person meets the requirement of the first designated standing posture” includes: obtaining a first visible light image of the body of the checked person in the first standing posture, and determining whether the first standing posture of the checked person meets the requirement of the first designated standing posture based on the first visible light image; and/or the “determining whether the second standing posture of the checked person meets the requirement of the second designated standing posture” includes: obtaining a second visible light image of the body of the checked person in the second standing posture, and determining whether the second standing posture of the checked person meets the requirement of the second designated standing posture based on the second visible light image.

In some embodiments, whether the first standing posture of the checked person meets the requirement of the first designated standing posture is determined based on the first millimeter-wave human body image; and/or whether the second standing posture of the checked person meets the requirement of the second designated standing posture is determined based on the second millimeter-wave human body image.

According to embodiments of another aspect of the present disclosure, there is provided a system of millimeter-wave human body security checking based on double standing postures, including:
a millimeter-wave human body security detector configured to:
   scan and check a body of a checked person in a first standing posture, so as to obtain a first millimeter-wave human body image, and
   scan and check the body of the same checked person in a second standing posture, so as to obtain a second millimeter-wave human body image, wherein the second standing posture is different from the first standing posture; and
a processor communicating with the millimeter-wave human body security detector and configured to determine whether the checked person carries contraband based on at least the first millimeter-wave human body image and the second millimeter-wave human body image.

In some embodiments, the millimeter-wave human body security detector has a scanning surface for scanning the body of the checked person, and the system of millimeter-wave human body security checking is configured to guide the first standing posture and the second standing posture of the checked person so that a part of the body of the checked person scanned by the scanning surface when the body of the checked person is in the first standing posture is at least partially complementary to a part of the body of the checked person scanned by the scanning surface when the body of the checked person is in the second standing posture, and a combination of the first millimeter-wave human body image and the second millimeter-wave human body image obtained through a scanning of the millimeter-wave human body security detector forms a roughly complete contour image of the body of the checked person.

In some embodiments, the system of millimeter-wave human body security checking is configured to select the first standing posture and the second standing posture so that the combination of the first millimeter-wave human body image and the second millimeter-wave human body image obtained through the scanning of the millimeter-wave human body security detector at least includes images of front and sides of the body, armpits, inner and outer thighs, and inner arms of the checked person.

In some embodiments, the millimeter-wave human body security detector has a scanning surface for scanning the body of the checked person, and the system of millimeter-wave human body security checking further includes a guidance device, and the guidance device is configured to: guide or instruct the checked person to stand at a designated security checking position in the first standing posture, so that a front or back of the body of the checked person faces the scanning surface; and/or guide or instruct the checked person to stand at a designated security checking position in the second standing posture, so that a side of the body of the checked person faces the scanning surface.

In some embodiments, the guidance device is configured to guide or instruct the checked person to stand at the designated security checking position in the first standing posture or the second standing posture by at least one of a voice prompt and a visual prompt.

In some embodiments, the guidance device includes: a voice prompt device configured to prompt the checked person to stand at the designated security checking position in the first standing posture or the second standing posture in a voice mode; and/or a display device disposed near the millimeter-wave human body security detector so as to be visible to the checked person, and configured to prompt the checked person to stand at the designated security checking position in the first standing posture or the second standing posture in a visual mode.

In some embodiments, the processor is further configured to: determine whether the first standing posture of the checked person meets a requirement of a first designated standing posture; and/or determine whether the second standing posture of the checked person meets a requirement of a second designated standing posture.

In some embodiments, the processor is further configured to: determine whether the first standing posture of the checked person meets the requirement of the first designated standing posture before scanning and checking the body of the checked person in the first standing posture by using the millimeter-wave human body security detector; and/or determine whether the second standing posture of the checked person meets the requirement of the second designated standing posture before scanning and checking the body of the checked person in the second standing posture by using the millimeter-wave human body security detector.

In some embodiments, the system of millimeter-wave human body security checking further includes: a camera device configured to acquire a first visible light image of the body of the checked person in the first standing posture and a second visible light image of the body of the checked person in the second standing posture, wherein the processor is further configured to: determine whether the first standing posture of the checked person meets the requirement of the first designated standing posture based on the first visible light image; and/or determine whether the second standing posture of the checked person meets the requirement of the second designated standing posture based on the second visible light image.

In some embodiments, the processor is further configured to: determine whether the first standing posture of the checked person meets the requirement of the first designated standing posture based on the first millimeter-wave human body image; and/or determine whether the second standing posture of the checked person meets the requirement of the second designated standing posture based on the second millimeter-wave human body image.

Other objects and advantages of the present disclosure will become apparent through the following detailed description of the present disclosure with reference to the accompanying drawings, which may assist in a comprehensive understanding of the present disclosure.

### BRIEF DESCRIPTION OF THE DRAWINGS

The features and advantages of the present disclosure may be more clearly understood with reference to the accompanying drawings, and the accompanying drawings are schematic and should not be construed as any limitation on the present disclosure.

FIG. 1 is a schematic diagram showing an arrangement of a system of millimeter-wave human body security checking according to exemplary embodiments of the present disclosure.

FIG. 2 is a schematic diagram showing a first designated standing posture for a checked person according to an exemplary embodiment of the present disclosure.

FIG. 3 is a schematic diagram showing a second designated standing posture for a checked person according to an exemplary embodiment of the present disclosure.

FIG. 4 is a schematic diagram showing a distribution of key points for identifying a first standing posture of a checked person according to an exemplary embodiment of the present disclosure.

FIG. 5 is a flowchart showing a method of millimeter-wave human body security checking according to embodiments of the present disclosure.

FIG. 6 is a flowchart showing a method of millimeter-wave human body security checking according to an example of the present disclosure.

### DETAILED DESCRIPTION OF EMBODIMENTS

Technical solutions in embodiments of the present disclosure will be described clearly and completely in combination with the accompanying drawings in embodiments of the present disclosure. It is obvious that the embodiments described are only some embodiments of the present disclosure, rather than all embodiments. All other embodiments, which may be derived by those of ordinary skill in the art from embodiments in the present disclosure without creative labor, fall within the scope of protection of the present disclosure.

In addition, in the following detailed descriptions, for purposes of explanation, numerous specific details are set forth in order to provide a thorough understanding of embodiments of the present disclosure. It is obvious, however, that one or more embodiments may be implemented without these specific details. In other instances, well-known structures and devices are shown in a form of illustration to simplify the accompanying drawings.

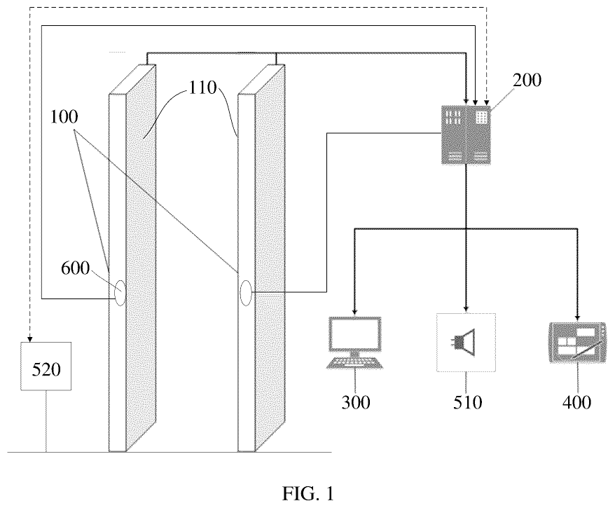

FIG. 1 schematically shows an arrangement of a system of millimeter-wave human body security checking according to exemplary embodiments of the present disclosure. As shown in FIG. 1, the system of security checking includes a human body imaging device, such as a millimeter-wave human body security detector 100, which is used to scan and check a body of a checked person to obtain a millimeter-wave human body image or corresponding scanning data. For example, the millimeter-wave human body security detector may achieve imaging by collecting a millimeter-wave radiation of a target or by collecting a millimeter-wave reflected or scattered by a target based on a passive or passive millimeter-wave imaging technology. For example, the millimeter-wave human body security detector may include millimeter-wave transceiver devices, such as a millimeter-wave antenna array for transmitting and receiving a millimeter-wave signal and a millimeter-wave transceiver associated with the millimeter-wave antenna array.

The millimeter-wave human body security detector may be divided into a cylindrical scanning system, a plane scanning system and a plane array scanning system. In the illustrated embodiment, the millimeter-wave human body security detector 100 is in form of a security checking gate. The security checking gate defines a checking channel, and the checked person stands at a designated position in the checking channel in a proper standing posture to accept the security checking. For example, the millimeter-wave human body security detector may include a linear array plane up-down scanning type security checking gate, a linear array plane left-right scanning type security checking gate, a broken line array up-down scanning security checking gate, a linear array turntable rotating security checking gate, or an arc or a cylindrical scanning type security checking gate. Correspondingly, the millimeter-wave human body security detector may have different forms of scanning surfaces for scanning the body of the checked person, such as a plane array scanning surface 110 shown in FIG. 1.

According to embodiments of the present disclosure, the body of the same checked person in different standing postures (for example, at least two standing postures) may be scanned and checked by using the millimeter-wave human body security detector, so as to reduce or avoid the problem of mutual occlusion between different parts of the human body, improve an accuracy of carrying inspection of contraband in human body security checking, reduce under-reporting, and improve a security checking efficiency of the device. For example, the millimeter-wave human body security detector may be used to scan and check the body of the same checked person in first and second standing postures that are different from each other, so as to obtain a first millimeter-wave human body image and a second millimeter-wave human body image respectively.

The system of human body security checking further includes a processor 200, such as a data or image processing device, which communicates with the millimeter-wave human body security detector 100, receives the scanning data or millimeter-wave human body image from the millimeter-wave human body security detector, determines whether the checked person carries contraband based on at least a combination of different millimeter-wave human body images of the same checked person in different standing postures, e.g., based on at least the first millimeter-wave human body image and the second millimeter-wave human body image, and outputs a result obtained from different standing postures after comprehensive processing, wherein the comprehensive processing may include denoising, merging duplicate results, and the like.

The system of human body security checking may further include a display device for displaying a security checking image and/or a determination result of the processor 200. For example, in the illustrated embodiment, the system of human body security checking may include at least one of a device-side security checking image display device 300 and an operator-side security checking image display device 400 communicating with the processor 200, so that an operator may view and process a security checking result, such as allowing the checked person to pass, or guiding the checked person suspected of carrying contraband to accept further checking. These display devices may be provided separately or integrated in a central control room or operation console.

In a plurality of embodiments according to the present disclosure, different standing postures of the same checked person may be selected so that parts of the body of the checked person scanned by the scanning surface 110 when the body of the checked person in different standing postures are at least partially complementary, for example, a part of the body of the checked person scanned by the scanning surface 110 when the body of the checked person is in the first standing posture is at least partially complementary to a part of the body of the checked person scanned by the scanning surface 110 when the body of the checked person is in the second standing posture, so that a combination of different millimeter-wave human body images of the same checked person in different standing postures obtained by a scanning of the millimeter-wave human body security detector may form a roughly complete contour image of the body of the checked person, which may improve an imaging quality.

For example, different standing postures of the same checked person are selected or specified, so that a first part of the body of the checked person is scanned by the scanning surface when the body of the checked person is in the first standing posture, and a second part of the body of the checked person is scanned by the scanning surface when the body of the checked person is in the second standing posture different from the first standing posture. The second part of the body of the checked person includes a part with poor imaging quality when scanning the checked person in the first standing posture, that is, the second part of the body of the checked person and the first part of the body of the checked person are at least partially different and are effectively scanned respectively, so that a high-quality image may be obtained and a detection accuracy may be improved. For example, different standing postures of the checked person may be selected or specified, so that a combination of different millimeter-wave human body images obtained by the scanning of the millimeter-wave human body security detector when the same checked person is in different standing postures at least includes images of front and sides of the body, armpits, inner and outer thighs, and inner arms of the checked person.

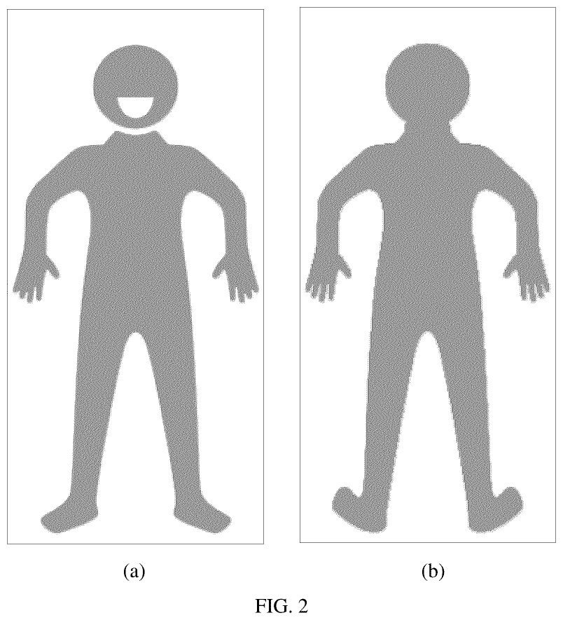

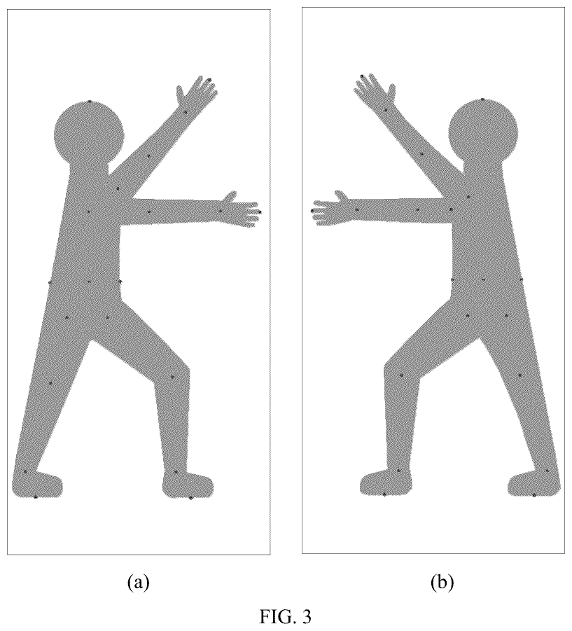

In some examples, the system of human body security checking sets different designated standing postures, and guides the checked person to accept scanning and checking in a standing posture that is basically consistent with the designated standing posture. FIG. 2 shows an exemplary first designated standing posture, wherein (a) shows a front view of the checked person in the first designated standing posture, and (b) shows a back view of the checked person in the first designated standing posture. In the first designated standing posture shown in FIG. 2, the front and/or back of the body of the checked person faces the scanning surface of the millimeter-wave human body security detector or the security checking gate thereof, the legs stand separately, and the arms are extended away from the body trunk and unfolded, such as forming an approximate m-shape with the body trunk, so as to expose the inner arms and armpit parts for scanning and checking. FIG. 3 shows an exemplary second designated standing posture, wherein (a) shows a right side view of the checked person in the second designated standing posture, and (b) shows a left side view of the checked person in the second designated standing posture. In the second designated standing posture shown in FIG. 3, the side of the body of the checked person faces the scanning surface of the millimeter-wave human body security detector or the security checking gate thereof, the legs stand separately, e.g., front and back, so that the inner sides of the legs are exposed, and the arms are extended away from the body trunk and unfolded, e.g., the arms are extended in different directions, so as to expose the inner arms and/or the armpit parts for scanning and checking. It will be understood that the designated standing postures shown in FIG. 2 and FIG. 3 are only schematic, and the system of human body security checking according to embodiments of the present disclosure may further guide the checked person to accept the security checking in other suitable and at least partially complementary different standing posture.

In addition to or in lieu of a manual guidance mode in which the operator guides the checked person to stand at the designated security checking position in a standing posture that is basically consistent with or coincident with the designated standing posture, the system of human body security checking according to embodiments of the present disclosure may include a guidance device, which is used to guide the checked person to stand at the designated security checking position in the standing posture which is basically consistent with or coincident with the designated standing posture to accept the security checking. As an example, the guidance device may guide or instruct the checked person to stand at the designated security checking position in the first standing posture that is basically consistent with or coincident with the first designated standing posture, so that the front or back of the body of the checked person faces the scanning surface of the security detector, and/or the guidance device may guide or instruct the checked person to stand at the designated security checking position in the second standing posture that is basically consistent with or coincident with the second designated standing posture, so that the side of body of the checked person faces the scanning surface.

For example, the guidance device may guide or instruct the checked person to stand at the designated security checking position in the standing posture that is basically consistent with or coincident with the designated standing posture by a voice prompt and/or a visual prompt. For example, as shown in FIG. 1, the guidance device may include a voice prompt device 510 and/or a display device 520. The voice prompt device 510 may be, for example, a speaker used to prompt the checked person to stand at the designated security checking position in the standing posture that is basically consistent with or coincident with the designated standing posture with voice or audio information (such as playing a prompt sound), and the display device 520 may be, for example, a display screen or indicator used to prompt the checked person to stand at the designated security checking position in the standing posture that is basically consistent with or coincident with the designated standing posture in a visual mode (such as a picture, an animation, a text, etc.). The display device 520 may be disposed near the millimeter-wave human body security detector, such as near an entrance of the checking channel, so as to be visible to the checked person.

In embodiments of the present disclosure, the system of human body security checking guides the checked person to accept the scanning and checking in the standing posture that is basically consistent with the designated standing posture. For this purpose, whether the standing posture of the checked person meets a requirement of the designated standing posture may be determined in a manual or automatic mode. In the manual mode, the operator may determine whether the standing posture of the checked person is basically consistent or coincident with the designated standing posture by the naked eyes based on the standing posture of the checked person at the designated inspection position or an image of the standing posture of the checked person. Alternatively or additionally, whether the standing posture of the checked person meets the requirement of the designated standing posture may also be determined in the automatic mode, for example, by means of a processor. For example, the processor may determine whether the standing posture meets the requirement of the designated standing posture based on the images of the body of the checked person in different standing postures.

For example, whether the standing posture of the checked person meets the requirement of the designated standing posture may be determined before scanning and checking the body of the checked person in a standing posture by using the millimeter-wave human body security detector. As an example, the determination criteria may include whether the different standing postures of the same checked person or the scanned parts of the different standing postures are complementary, and whether the different standing postures of the same checked person ensure that the body parts (such as sides of the trunk, armpits, inner arms, inner and outer thighs, and even including soles) with slightly poor imaging quality in the routine checking may be scanned and clearly imaged.

As shown in FIG. 1, the system of human body security checking may further include a camera device 600, which is used to acquire visible light images of the body of the checked person in different standing postures. The camera device 600 may communicate with the processor 200, and the processor 200 may determine whether the standing posture of the checked person meets the requirement of the designated standing posture based on the visible light images of the body of the checked person in different standing postures. If the standing posture of the checked person meets the requirement of the designated standing posture, it may be determined that the standing posture of the checked person is consistent with the designated standing posture; at this point, the determination result may be automatically fed back to the security detector, and the security detector may start the scanning and checking based on this. If the standing posture of the checked person does not meet the requirement of the designated standing posture, the system may feedback the determination result to the checked person and/or the operator (such as via the guidance device or via the display device 300 or 400). The camera device 600 may also communicate with the display device 300 or 400 to display the obtained visible light image of the body of the checked person on the display device 300 or 400, and the operator may manually determine whether the standing posture of the checked person meets the requirement of the designated standing posture.

In some embodiments, the operator or the processor 200 may determine whether the standing posture of the checked person meets the requirement of the designated standing posture based on the obtained millimeter-wave human body image. If the standing posture of the checked person meets the requirement of the designated standing posture, the checked person may be guided to accept the security checking in a next standing position or end the checking. If the standing posture of the checked person does not meet the requirement of the designated standing posture, the checked person may be guided to change the standing posture until the standing posture is consistent with the designated standing posture.

Whether the standing posture of the checked person is correct or conforms to the requirement of the designated standing posture may be determined based on the image of the checked person in a variety of ways. For example, whether a difference (such as a difference of a figure boundary) between a figure image corresponding to the designated standing posture and the visible light image is within a predetermined threshold range may be determined. The following description will be given by taking a mode of determining whether the standing posture is correct or meets the requirement of the designated standing posture based on key points on the human body as an example.

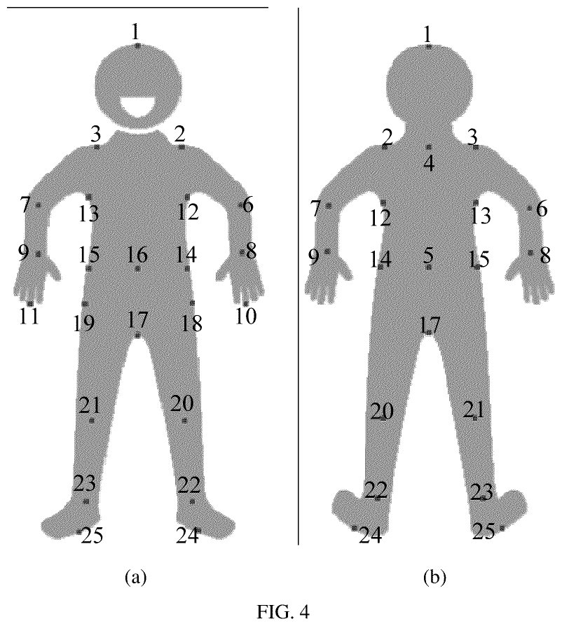

For example, coordinates of a plurality of key points on the human body may be determined, and then comprehensive determination may be performed according to a coordinate relationship between the key points. For example, as shown in FIG. 4, when the checked person is scanned and checked in the standing posture shown in FIG. 2, the plurality of key points on the human body include, but are not limited to: 1. top of head; 2. left shoulder; 3. right shoulder; 4. cervical vertebra; 5. midpoint of back waist (for a back image); 6. left elbow; 7. right elbow; 8. left wrist; 9. right wrist; 10. left-hand fingertip; 11. right-hand fingertip; 12. left armpit; 13. right armpit; 14. left crotch; 15. right crotch; 16. navel (for a front image); 17. crotch bottom point; 18. starting point of left groin; 19. starting point of right groin; 20. left knee; 21. right knee; 22. left ankle; 23. right ankle; 24. left sole; 25. right sole. A coordinate system may take an upper-left vertex of an original image as an origin, horizontal right as a positive direction of the x-axis, and vertical down as a positive direction of the y-axis. In practice, according to projection features of the original data in different directions, the coordinates of the designated points may be acquired by combining, for example, a method of regression analysis, or the operator or device may mark the key points in the obtained image according to experience. After acquiring the coordinates of the designated points, the corresponding data may be processed according to the following steps, and whether the standing posture of the checked person is correct may be determined. The front side and reverse (back) side may be processed in a similar way, such as adjusting the relationship of some points according to the corresponding a relationship between the front side and reverse (back) side.

In Step 1, a midpoint between the left shoulder and the right shoulder, a midpoint between the left crotch and the right crotch, and a midpoint between the left knee and the right knee are calculated.

In Step 2, according to coordinates of the left and right fingertips, the left and right wrists, the left and right elbows and the left and right shoulders, included angles of a left upper arm, a left lower arm, a right upper arm and a right lower arm with the horizontal direction are calculated respectively, and the four angles are defined as ∠A, ∠B, ∠C, and ∠D; included angles of connecting lines between the cervical vertebra point and the left and right shoulder points with the horizontal direction are calculated, and the two angles are defined as ∠E and ∠F; all angles are positive.

In Step 3, according to the calculation results in Step 1 and Step 2, whether the image meets the following requirements is checked.
a. Whether the three midpoints calculated in Step 1, the point of top of head, the midpoint of back waist or the navel are located at a region near a horizontal central axis of the image;
b. Whether the abscissa of each point meets:
   (1) left wrist≤left elbow<left shoulder<cervical vertebra<right shoulder<right elbow≤right wrist;
   (2) left fingertip≤left elbow<left armpit<cervical vertebra<right armpit<right elbow≤right fingertip;
   (3) left elbow<left crotch<midpoint of back waist<right crotch<right elbow;
   (4) left ankle≤left knee<crotch bottom point<right knee≤right ankle;
   (5) left sole<right sole;
c. Whether the longitudinal coordinate of each point meets:
   (1) the vertical coordinate of the point of top of head is the smallest, that is, the height is the highest; the vertical coordinates of the left and right soles are the largest, that is, the height is the lowest;
   (2) left shoulder≤left elbow<left wrist<left fingertip; right shoulder≤right elbow<right wrist<right fingertip;
   (3) left shoulder<left armpit<midpoint of back waist<left crotch<crotch bottom point; right shoulder<right armpit<right waist midpoint<right crotch<crotch bottom point;
   (4) crotch bottom point<left knee<left ankle<left sole; crotch bottom point<right knee<right ankle<right sole;
d. ∠A<∠B; ∠C<∠D;
e. ∠E≤20°; ∠F≤20′;
f. A position relationship between other points conforms to a normal shape of human body.

When the image meets all the conditions in Step 3, it may be determined that the scanning standing posture corresponding to the image is correct or meets the requirement of the designated standing posture. Otherwise, it may be determined that the scanning standing posture is incorrect and a corresponding result is output.

When the checked person is scanned and checked in the standing posture shown in FIG. 3, a plurality of key points on the human body are schematically shown as black spots in FIG. 3, including but not limited to: top of head; starting point of left arm; left elbow; left wrist; left fingertip; starting point of right arm; right elbow; right wrist; right fingertip; midpoint of waist; front waist; back waist; starting point of left thigh; starting point of right thigh; left knee; right knee; left ankle; right ankle; left sole; and right sole. The coordinate system in the scanned image may be the same as the scanned image of the standing posture in FIG. 2. It may be defined that the image of the checked person facing the right side is a front image, and the image of the checked person facing the left side is a reverse image. The front image is taken as an example to illustrate the determination criteria of the standing posture. The criteria of processing the reverse image correspond to the criteria of processing the front image according to the coordinate relationship.

In Step 1′, according to the coordinates of the starting point of the arm, point of the elbow, and the wrist, included angles of the left upper arm, the left lower arm, the right upper arm and the right lower arm with the horizontal direction are calculated, and the four angles are defined as ∠A, ∠B, ∠C, and ∠D; in addition, the included angles between the left upper arm and the left lower arm, and between the right upper arm and the right lower arm are calculated, and the two angles are defined as ∠E and ∠F; all angles are positive.

In Step 2′, according to the calculation results in Step 1′ and the coordinate of each point, whether the image meets the following requirements is checked.
a. Whether the abscissa of each point meets:
   (1) starting point of left arm<left elbow<left wrist<left fingertip; starting point of right arm<right elbow<right wrist<right fingertip;
   (2) top of head<right elbow; top of head<left elbow; back waist<top of head<front waist; starting point of right thigh<top of head<starting point of left thigh; right knee<top of head<left knee; right ankle<top of head<left ankle; right sole<top of head<left sole;
   (3) back waist<starting point of left arm, starting point of right arm, midpoint of waist<front waist; starting point of right thigh<starting point of left arm, starting point of right arm, midpoint of waist<starting point of left thigh; right knee<starting point of left arm, starting point of right arm, midpoint of waist<left knee; right ankle<starting point of left arm, starting point of right arm, midpoint of waist<left ankle; right sole<starting point of left arm, starting point of right arm, midpoint of waist<left sole;
   (4) left fingertip<right fingertip;
   (5) right ankle≤right knee<starting point of right thigh; starting point of left thigh<left knee≤left ankle;
b. Whether the longitudinal coordinate of each point meets:
   (1) the top of the head is the highest point except the left fingertip and the left wrist, that is, left fingertip<left wrist<top of head<other points; the left and right soles are the lowest points, that is, left and right soles>other points;
   (2) left fingertip<left wrist<left elbow<starting point of left arm; right fingertip≤right wrist≤right elbow starting point of right arm; left elbow≤right fingertip;
   (3) starting points of left and right big arms<front waist, back waist, midpoint of waist<starting points of left and right thighs<left and right knees<left and right ankles<left and right soles;
c. 30°≤∠A≤60°; 30°≤∠B≤60′;
d. ∠C≤10′; ∠D≤10′;
e. ∠E≤20°; ∠F≤20′;
f. A position relationship between other points conforms to a normal shape of human body.

When the image meets all the conditions in Step 2′, it is determined that the scanning standing posture of the front image is correct; otherwise, it is determined that the scanning standing posture is incorrect, and a corresponding result is output. As some examples, a final determination result of the standing posture may be given by combining the results of the front image and the reverse image. For example, when the determination result is accurately required, a relevant prompt of “standing posture is correct” may be output only when both the front and reverse images give a conclusion of “standing posture is correct”. Otherwise, the information of “standing posture is wrong” may be output and the checked person is prompted to be scanned again.

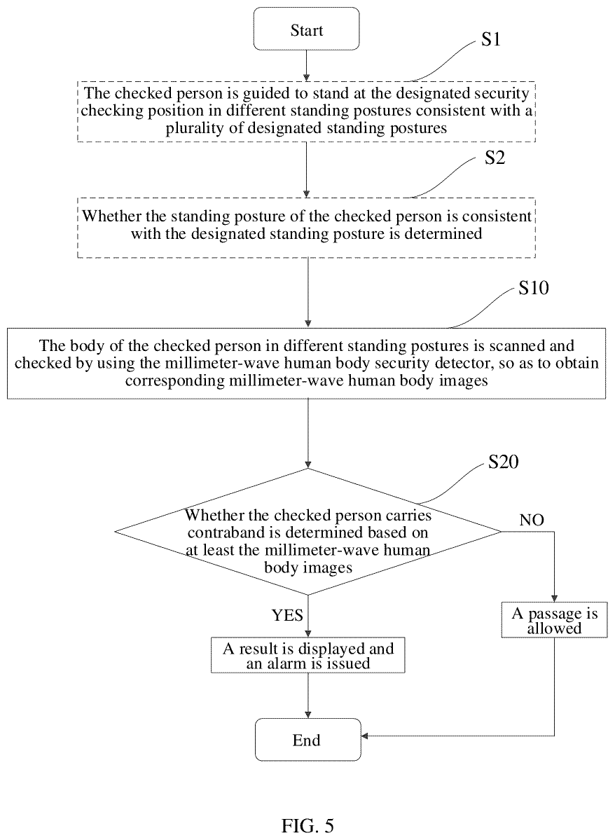

Embodiments of the present disclosure further provide a method of human body security checking, which may be millimeter-wave human body scanning based on double standing postures, and may be achieved by, for example, the above-mentioned system of human body security checking. FIG. 5 illustrates a flowchart of a method of millimeter-wave human body security checking according to exemplary embodiments of the present disclosure. The method mainly includes the following steps.

In S10, a body of a checked person in different standing postures is scanned and checked by using a millimeter-wave human body security detector, so as to obtain corresponding millimeter-wave human body images. For example, the body of the same checked person in a first standing posture and a second standing posture different from the first standing posture is scanned and checked by using the millimeter-wave human body security detector, so as to obtain a first millimeter-wave human body image and a second millimeter-wave human body image respectively.

In S20, whether the checked person carries contraband is determined based on at least the obtained millimeter-wave human body images.

When it is determined that the checked person is suspected of carrying contraband, the result may be displayed to the operator, and an alarm may be issued when necessary to guide the checked person, who is suspected of carrying contraband, to accept further checking. When it is determined that the checked person does not carry any contraband, the checked person may be allowed to pass, and then the security checking for a next checked person may be continued.

In the method, the first standing posture and the second standing posture may be selected so that a part of the body of the checked person scanned by the scanning surface when the body of the checked person is in the first standing posture is at least partially complementary to a part of the body of the checked person scanned by the scanning surface when the body of the checked person is in the second standing posture, so that a combination of the first millimeter-wave human image and the second millimeter-wave human image obtained may form a roughly complete contour image of the body of the checked person or cover most of the parts of the body of the checked person, which include the parts with poor imaging quality in the routine checking, such as sides of the body, armpits, inner and outer thighs, inner arms, soles and other parts of the checked person. For example, when the checked person stands at the designated security checking position in the first standing posture, the front or back of the body of the checked person faces the scanning surface of the security detector, while when the checked person stands at the designated security checking position in the second standing posture, the side of the body of the checked person faces the scanning surface. For example, the first standing posture may be the standing posture shown in FIG. 2, while the second standing posture may be the standing posture shown in FIG. 3. However, the present disclosure is not limited to this.

In some embodiments, the guidance device, such as the devices 510 and 520 shown in FIG. 1, may guide or instruct the checked person to stand at the designated security checking position in the standing posture consistent with or coincident with the designated standing posture by using at least one of the voice prompt and the visual prompt (see Step S1 in FIG. 5).

Further, the method may further include determining whether the different standing postures of the checked person meet the requirements of the corresponding designated standing postures (see Step S2 in FIG. 5). For example, the operator may perform a manual determination based on the standing posture or standing posture image of the checked person, or the system may perform an automatic determination based on the standing posture image of the checked person. For example, whether the standing posture of the checked person meets the requirement of the corresponding designated standing posture may be determined before the body of the checked person in a standing posture is scanned and checked by using the millimeter-wave human body security detector, so that a desired image may be obtained from each scanning. For example, before the body of the checked person in a standing posture is scanned and checked by using the millimeter-wave human body security detector, a visible light image of the body of the checked person in the standing posture may be obtained, and whether the standing posture of the checked person meets the requirement of the designated standing posture may be determined based on the visible light image. In addition, such determination may also be performed based on the obtained millimeter-wave human body image. For example, when most of the checked people may accept the security checking according to the designated standing posture, especially when the appropriate posture guidance device is provided, this may save time, improve the traffic efficiency, and do not need to provide a separate portrait acquisition device.

In the illustrated embodiment, when the processor 20 determines that the standing posture of the checked person is incorrect, the corresponding information is transmitted to the security checking image display device 300 or 400, and the corresponding information may be further transmitted to the guidance device 510 and/or 520. The image display device 300 or 400 displays the prompt information of incorrect standing posture, and at the same time, the guidance device 510 and/or 520 prompts that the standing posture of the checked person is incorrect, and the checked person should adjust the standing posture to be scanned again. If the standing posture of the checked person is correct, the millimeter-wave image may be recognized, and the recognition result may be temporarily stored, and whether another standing posture scanning is performed may be determined. If another standing posture scanning is performed, the above-mentioned process may be repeated, and the recognition result may be temporarily stored. After a completion of all standing posture scanning, the recognition results of all standing postures may be comprehensively processed, such as dividing the human body into different regions according to the key points determined during the standing posture determination, calculating which region an alarm box falls in according to the coordinates and size of an alarm region, performing the above-mentioned processing on each alarm box to obtain the region information of the alarm box, and then traversing all the alarm boxes and merging the duplicate alarm results, so as to obtain the comprehensive output result. After that, the final recognition result is output to the devices 300, 400 and/or the guidance devices 510 and 520, and a prompt that whether the checked person carries contraband is given according to the recognition result. In addition, the system and method of human body security checking according to the present disclosure may only perform single standing scanning.

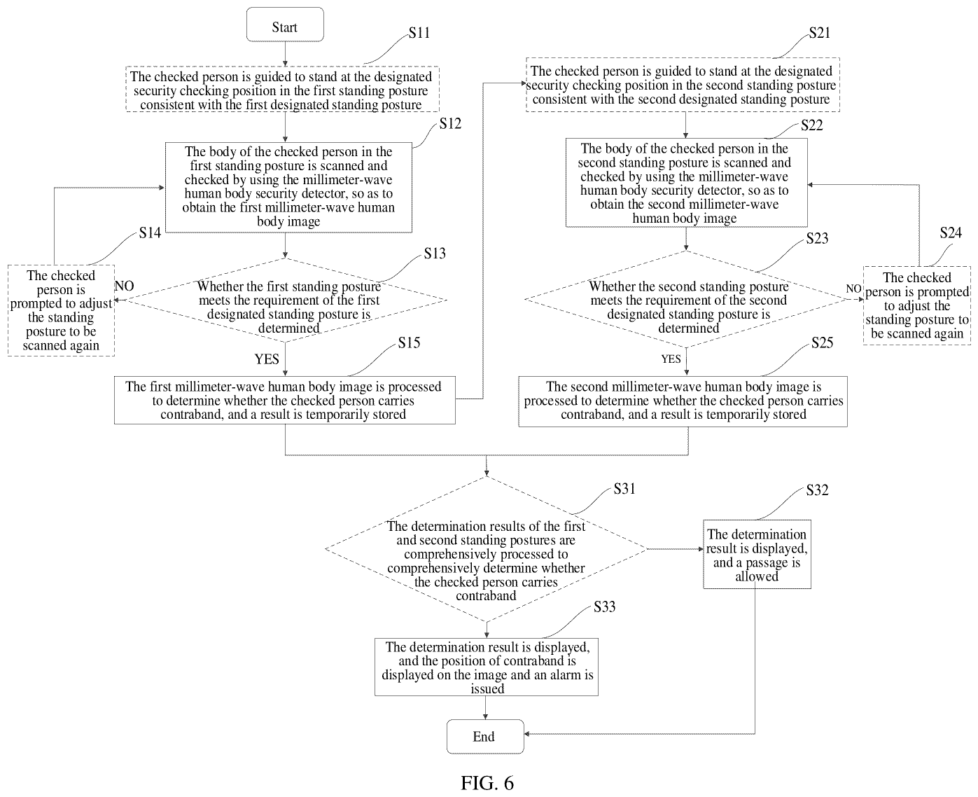

FIG. 6 illustrates a method of millimeter-wave human body security checking according to a specific example of the present disclosure. As shown in FIG. 6, the method includes the following steps.

In S11, the checked person is guided to enter the designated security checking position, put out the first standing posture consistent with the first designated standing posture, and wait for the security checking.

In S12, the millimeter-wave human body security detector scans the checked person in the first standing posture and collects the first millimeter-wave human body image.

In S13, whether the first standing posture of the checked person meets the requirement of the first designated standing posture is determined. If it is determined that the first standing posture of the checked person is inconsistent with the first designated standing posture or incorrect, the information of incorrect standing posture may be transmitted to the guidance device to prompt the checked person to correct the posture (see Step S14), and the scanning may be performed again after the checked person has adjusted the posture. Step S13 is repeated until it is determined that the standing posture of the checked person is correct. If the first standing posture of the checked person is consistent with the first designated standing posture, proceed to Step S15.

In S15, the first millimeter-wave human body security checking image is processed, whether the checked person carries contraband is determined, and a result is temporarily stored. If double standing postures scanning is performed, proceed to Step S21; otherwise, proceed directly to step S33 and transmit the existing result to the operator as the comprehensive result;

In S21, the checked person is instructed to switch the standing posture to the second standing posture consistent with the second designated standing posture, and wait for the security checking.

In S22: the millimeter-wave human body security detector scans the checked person in the second standing posture and collects the second millimeter-wave human body image.

In S23, whether the second standing posture of the checked person meets the requirement of the second designated standing posture is determined. If it is determined that the second standing posture of the checked person is inconsistent with the second designated standing posture or incorrect, the information of incorrect standing posture may be transmitted to the guidance device to prompt the checked person to correct the posture (see Step S24), and the scanning may be performed again after the checked person has adjusted the posture. Step S23 is repeated until it is determined that the standing posture of the checked person is correct. If the second standing posture of the checked person is consistent with the second designated standing posture, proceed to Step S25.

In S25, the second millimeter-wave human body security checking image is processed; whether the checked person carries contraband is determined, and a result is temporarily stored; proceed to Step S31.

In S31, the determination results of different standing postures are comprehensively processed. The human body image is partitioned according to the key points. The region of the alarm position is determined. The information such as the alarm position and the like is subjected to duplicate removal processing, so as to obtain the comprehensive result. If the comprehensive result shows that the checked person does not carry any contraband, proceed to step S32, the determination result is displayed, and the checked person is allowed to pass. If the comprehensive result shows that the checked person carries contraband, proceed to step S33. For example, the position of contraband is outlined by a specific color on the millimeter-wave image of the checked person and the figure image of the display device, and the result is transmitted to the guidance device. The display device displays the checking result and prompts that the checked person carries contraband, and an alarm is issued. In embodiments illustrated in FIG. 5 and FIG. 6, optional steps are shown in dashed boxes.

Embodiments of the present disclosure have been shown and described. However, those of ordinary skill in the art may understand that these embodiments may be changed without departing from the principle and spirit of the present disclosure, and the scope of the present disclosure is defined by the appended claims and their equivalents.

1. A method of millimeter-wave human body security checking based on double standing postures, comprising:
scanning and checking a body of a checked person in a first standing posture by using a millimeter-wave human body security detector, so as to obtain a first millimeter-wave human body image;
scanning and checking the body of the same checked person in a second standing posture by using the millimeter-wave human body security detector, so as to obtain a second millimeter-wave human body image, wherein the second standing posture is different from the first standing posture; and
determining whether the checked person carries contraband based on at least the first millimeter-wave human body image and the second millimeter-wave human body image.

2. The method of millimeter-wave human body security checking according to claim 1, wherein the millimeter-wave human body security detector has a scanning surface for scanning the body of the checked person, and
the method further comprises:
guiding the first standing posture and the second standing posture of the checked person, so that a part of the body of the checked person scanned by the scanning surface when the body of the checked person is in the first standing posture is at least partially complementary to a part of the body of the checked person scanned by the scanning surface when the body of the checked person is in the second standing posture, and a combination of the first millimeter-wave human body image and the second millimeter-wave human body image obtained forms a roughly complete contour image of the body of the checked person.

3. The method of millimeter-wave human body security checking according to claim 2, wherein the first standing posture and the second standing posture are selected so that the combination of the first millimeter-wave human body image and the second millimeter-wave human body image at least comprises images of front and sides of the body, armpits, inner and outer thighs, and inner arms of the checked person.

4. The method of millimeter-wave human body security checking according to claim 1, wherein the millimeter-wave human body security detector has a scanning surface for scanning the body of the checked person, and the method further comprises:
guiding or instructing the checked person to stand at a designated security checking position in the first standing posture, so that a front or back of the body of the checked person faces the scanning surface; and/or
guiding or instructing the checked person to stand at a designated security checking position in the second standing posture, so that a side of the body of the checked person faces the scanning surface.

5. The method of millimeter-wave human body security checking according to claim 4, wherein at least one of a voice prompt and a visual prompt is used to guide or instruct the checked person to stand at the designated security checking position in the first standing posture or the second standing posture through a guidance device.

6. The method of millimeter-wave human body security checking according to claim 1, further comprising:
determining whether the first standing posture of the checked person meets a requirement of a first designated standing posture; and/or
determining whether the second standing posture of the checked person meets a requirement of a second designated standing posture.

7. The method of millimeter-wave human body security checking according to claim 6,
wherein whether the first standing posture of the checked person meets the requirement of the first designated standing posture is determined before scanning and checking the body of the checked person in the first standing posture by using the millimeter-wave human body security detector; and/or
wherein whether the second standing posture of the checked person meets the requirement of the second designated standing posture is determined before scanning and checking the body of the checked person in the second standing posture by using the millimeter-wave human body security detector.

8. The method of millimeter-wave human body security checking according to claim 7,
wherein the determining whether the first standing posture of the checked person meets the requirement of the first designated standing posture comprises:
obtaining a first visible light image of the body of the checked person in the first standing posture, and determining whether the first standing posture of the checked person meets the requirement of the first designated standing posture based on the first visible light image; and/or
wherein the determining whether the second standing posture of the checked person meets the requirement of the second designated standing posture comprises:
obtaining a second visible light image of the body of the checked person in the second standing posture, and determining whether the second standing posture of the checked person meets the requirement of the second designated standing posture based on the second visible light image.

9. The method of millimeter-wave human body security checking according to claim 6,
wherein whether the first standing posture of the checked person meets the requirement of the first designated standing posture is determined based on the first millimeter-wave human body image; and/or
wherein whether the second standing posture of the checked person meets the requirement of the second designated standing posture is determined based on the second millimeter-wave human body image.

10. A system of millimeter-wave human body security checking based on double standing postures, comprising:
a millimeter-wave human body security detector configured to:
scan and check a body of a checked person in a first standing posture, so as to obtain a first millimeter-wave human body image, and
scan and check the body of the same checked person in a second standing posture, so as to obtain a second millimeter-wave human body image, wherein the second standing posture is different from the first standing posture; and
a processor communicating with the millimeter-wave human body security detector and configured to determine whether the checked person carries contraband based on at least the first millimeter-wave human body image and the second millimeter-wave human body image.

11. The system of millimeter-wave human body security checking according to claim 10, wherein the millimeter-wave human body security detector has a scanning surface for scanning the body of the checked person, and
the system of millimeter-wave human body security checking is configured to guide the first standing posture and the second standing posture of the checked person, so that a part of the body of the checked person scanned by the scanning surface when the body of the checked person is in the first standing posture is at least partially complementary to a part of the body of the checked person scanned by the scanning surface when the body of the checked person is in the second standing posture, and a combination of the first millimeter-wave human body image and the second millimeter-wave human body image obtained through a scanning of the millimeter-wave human body security detector forms a roughly complete contour image of the body of the checked person.

12. The system of millimeter-wave human body security checking according to claim 11, wherein the system of millimeter-wave human body security checking is configured to select the first standing posture and the second standing posture so that the combination of the first millimeter-wave human body image and the second millimeter-wave human body image obtained through the scanning of the millimeter-wave human body security detector at least comprises images of front and sides of the body, armpits, inner and outer thighs, and inner arms of the checked person.

13. The system of millimeter-wave human body security checking according to claim 10, wherein the millimeter-wave human body security detector has a scanning surface for scanning the body of the checked person, and the system of millimeter-wave human body security checking further comprises:
a guidance device configured to:
guide or instruct the checked person to stand at a designated security checking position in the first standing posture, so that a front or back of the body of the checked person faces the scanning surface; and/or
guide or instruct the checked person to stand at a designated security checking position in the second standing posture, so that a side of the body of the checked person faces the scanning surface.

14. The system of millimeter-wave human body security checking according to claim 13, wherein the guidance device is configured to guide or instruct the checked person to stand at the designated security checking position in the first standing posture or the second standing posture by at least one of a voice prompt and a visual prompt.

15. The system of millimeter-wave human body security checking according to claim 13, wherein the guidance device comprises:
a voice prompt device configured to prompt the checked person to stand at the designated security checking position in the first standing posture or the second standing posture in a voice mode; and/or
a display device disposed near the millimeter-wave human body security detector so as to be visible to the checked person, and configured to prompt the checked person to stand at the designated security checking position in the first standing posture or the second standing posture in a visual mode.

16. The system of millimeter-wave human body security checking according to claim 10, wherein the processor is further configured to:
determine whether the first standing posture of the checked person meets a requirement of a first designated standing posture; and/or
determine whether the second standing posture of the checked person meets a requirement of a second designated standing posture.

17. The system of millimeter-wave human body security checking according to claim 16, wherein the processor is further configured to:
determine whether the first standing posture of the checked person meets the requirement of the first designated standing posture before scanning and checking the body of the checked person in the first standing posture by using the millimeter-wave human body security detector; and/or
determine whether the second standing posture of the checked person meets the requirement of the second designated standing posture before scanning and checking the body of the checked person in the second standing posture by using the millimeter-wave human body security detector.

18. The system of millimeter-wave human body security checking according to claim 17, further comprising:
a camera device configured to acquire a first visible light image of the body of the checked person in the first standing posture and a second visible light image of the body of the checked person in the second standing posture,
wherein the processor is further configured to:
determine whether the first standing posture of the checked person meets the requirement of the first designated standing posture based on the first visible light image; and/or
determine whether the second standing posture of the checked person meets the requirement of the second designated standing posture based on the second visible light image.

19. The system of millimeter-wave human body security checking according to claim 16, wherein the processor is further configured to:
determine whether the first standing posture of the checked person meets the requirement of the first designated standing posture based on the first millimeter-wave human body image; and/or
determine whether the second standing posture of the checked person meets the requirement of the second designated standing posture based on the second millimeter-wave human body image.
